(19) United States
(12) Patent Application Publication
(10) Pub. No.: US 2025/0200742 A1
(43) Pub. Date: Jun. 19, 2025

(54) METHOD AND SYSTEM FOR OPTICAL FLOW GUIDED MULTIPLE-VIEW DEFECTS INFORMATION FUSION

(71) Applicant: AGENCY FOR SCIENCE, TECHNOLOGY AND RESEARCH, Singapore (SG)

(72) Inventors: Yusha LI, Singapore (SG); Jierong CHENG, Singapore (SG); Wei XIONG, Singapore (SG)

(73) Assignee: AGENCY FOR SCIENCE, TECHNOLOGY AND RESEARCH, Singapore (SG)

(21) Appl. No.: 18/847,091

(22) PCT Filed: Mar. 16, 2023
(86) PCT No.: PCT/SG2023/050168

§ 371 Date: Sep. 13, 2024

(30) Foreign Application Priority Data
Mar. 17, 2022 (SG) 10202202719W

(51) Int. Cl. G06T 7/00; G06T 7/215; G06T 7/246

(52) U.S. Cl. CPC G06T 7/001; G06T 7/215; G06T 7/246; G06T 2207/10016; G06T 2207/30241; G06T 2207/30242

(57) ABSTRACT

This disclosure relates to method and system for inspection of rotational components based on video frames having different camera views of defects on rotational components. Using optical flow to ascertain motion vectors of pixels of the video frames, the video frames are partitioned based on motion vectors. The partitioned regions are paired with corresponding regions in a subsequent video frame, and their features are matched. For video frames having at least camera motion, a transformation matrix is ascertained which is applied to map defect trajectories of each camera view to a subsequent camera view.

### TECHNICAL FIELD

This disclosure generally relates to visual based inspection of objects including rotational components such as rotating blades in aircraft engine, wind turbine, or water turbines, and real-time objects on conveying belt. In particular, the visual inspection may involve fusion or aggregation of defect information obtained from multiple camera views.

### BACKGROUND

Tracking of defects on rotational components from video sequences taken by a static or stable camera has its challenges.

Tracking of defects on rotational components from video sequences taken by a moving or non-stable camera has further challenges due to at least the following reasons:
Using image registration or direct feature matching is difficult due to changes in lighting and view angle.
A same defect in different views may have different appearances.
Some defects are detected in some views but undetected in the remaining views.
Some new defects appear when changing views.

### SUMMARY

According to a first aspect of the disclosure, a method for inspection of rotational components comprises:
based on successive frames of a plurality of video frames of the rotational components in motion, each video frame having a plurality of pixels, ascertaining a plurality of optical flow images for the video frames respectively by ascertaining a plurality of motion vectors of the pixels, wherein the successive video frames include a plurality of camera views;
based on the optical flow images, partitioning each video frame into a plurality of regions;
based on regions having substantially same optical flow characteristic and rotational component location, ascertaining a plurality of region pairs for the successive video frames and performing feature matching for the region pairs;
ascertaining a subset of the region pairs which correspond to a subset of the video frames having at least camera motion;
based on the feature matching of the subset of the region pairs, ascertaining a transformation matrix for the subset of the region pairs; and
based on the transformation matrix, performing mapping of a plurality of defect trajectories of each camera view to a subsequent camera view, wherein the camera views include the subsequent camera view.

In an embodiment of the first aspect, the method further comprises:
based on similarity of images of defects on each rotational component which correspond to a same one of the defect trajectories in each camera view and the subsequent camera view, ascertaining the defects as distinct defects or same defect.

In an embodiment of the first aspect, the method further comprises:
based on the ascertained distinct defects or same defect, ascertaining a count of distinct defects for each camera view.

In an embodiment of the first aspect, the defect trajectories include ellipse-based trajectories.

In an embodiment of the first aspect, the step of ascertaining the subset of the region pairs which correspond to the subset of the video frames having the at least camera motion includes: excluding some of the region pairs which include abnormal illumination and/or smooth region.

In an embodiment of the first aspect, the step of ascertaining the subset of the region pairs which correspond to the subset of the video frames having the at least camera motion includes: classifying the optical flow images and thereby ascertaining some of the optical flow images having the at least camera motion.

According to a second aspect of the disclosure, a system for inspection of rotational components, the system comprising:
a memory device storing a plurality of video frames; and
a computing processor communicably coupled to the memory device and configured to:
   based on successive frames of a plurality of video frames of the rotational components in motion, each video frame having a plurality of pixels, ascertain a plurality of optical flow images for the video frames respectively by ascertaining a plurality of motion vectors of the pixels, wherein the successive video frames include a plurality of camera views;
   based on the optical flow images, partition each video frame into a plurality of regions;
   based on regions having substantially same optical flow characteristic and rotational component location, ascertain a plurality of region pairs for the successive video frames and perform feature matching for the region pairs;
   ascertain subset of the region pairs which correspond to a subset of the video frames having at least camera motion;
   based on the feature matching of the subset of the region pairs, ascertain a transformation matrix for the subset of the region pairs;
   based on the transformation matrix, perform mapping of a plurality of ellipse-based trajectories of each camera view to a subsequent camera view, wherein the camera views include the subsequent camera view.

In an embodiment of the second aspect, the computing processor is further configured to:
based on similarity of images of defects on each rotational component which correspond to a same one of the ellipse-based trajectories in the each camera view and the subsequent camera view, ascertain the defects as distinct defects or same defect.

In an embodiment of the second aspect, the computing processor is further configured to:
based on the ascertained distinct defects or same defect, ascertain a count of distinct defects for each camera view.

In an embodiment of the second aspect, the defect trajectories include ellipse-based trajectories.

In an embodiment of the second aspect, the computing processor is configured to ascertain the subset of the region pairs which correspond to the subset of the video frames having the at least camera motion by being further configured to: exclude some of the region pairs which include abnormal illumination and/or smooth region.

In an embodiment of the second aspect, the computing processor is configured to ascertain the subset of the region pairs which correspond to the subset of the video frames having the at least camera motion by being further configured to: classify the optical flow images and thereby ascertaining some of the optical flow images having the at least camera motion.

### BRIEF DESCRIPTION OF THE DRAWINGS

FIG. 1 shows an overview flow sequence of a method for inspection of rotational components according to an embodiment.

FIGS. 2A to 2C show three video frames having different camera views.

FIG. 3A shows a video frame in which shows at least one rotational component.

FIG. 3B shows an optical flow image of the video frame of FIG. 3A.

FIG. 3C shows an optical flow image which is based on FIG. 3B and having various partitioned regions.

FIG. 4 shows Oriented FAST and Rotated BRIEF (ORB) feature matching of region pairs performed on the region pairs.

FIG. 5A shows three optical flow images with rotational component motion only.

FIG. 5B shows three optical flow images with camera motion only.

FIG. 5C shows three optical flow images with both rotational component and camera motion.

FIGS. 6A and 6B show trajectory mapping from the first camera view or video frame to the second camera view or video frame.

FIG. 7A shows defects having slightly different appearances in different illumination and view angle.

FIG. 7B is an example table having distance values of selected defects of FIG. 7A.

FIGS. 8A to 8C show the video sequence of FIGS. 2A to 2C, their corresponding trajectories of detected defects, and identification of at least some of the trajectory mappings.

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, including examples and claims, the articles “a”, “an” and “the” as used with regard to a feature or element include a reference to one or more of the features or elements. The terms “comprising,” “including,” and “having” are intended to be open-ended and mean that there may be additional features or elements other than the listed ones. The term “and/or” includes any and all combinations of one or more of the associated listed items.

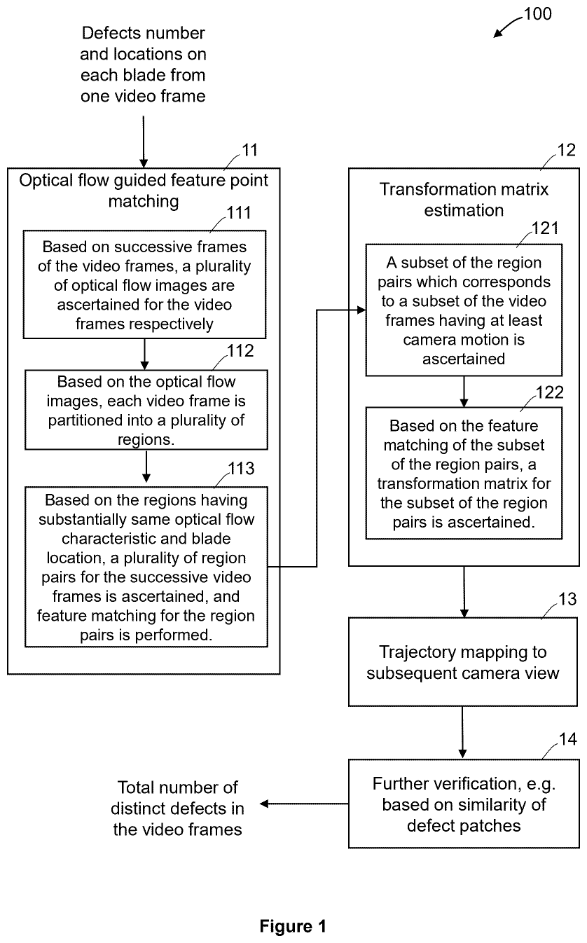

FIG. 1 shows an overview flow sequence 100 of a method for inspection of rotational components according to an embodiment.

The flow sequence 100 of FIG. 1 may be performed based on an obtained video sequence having a plurality of video frames of rotational components in motion, wherein at least some of the video frames include different camera views. Each video frame shows the locations and number of defects on each rotational component shown in the video frame. Each video frame comprises a plurality of pixels.

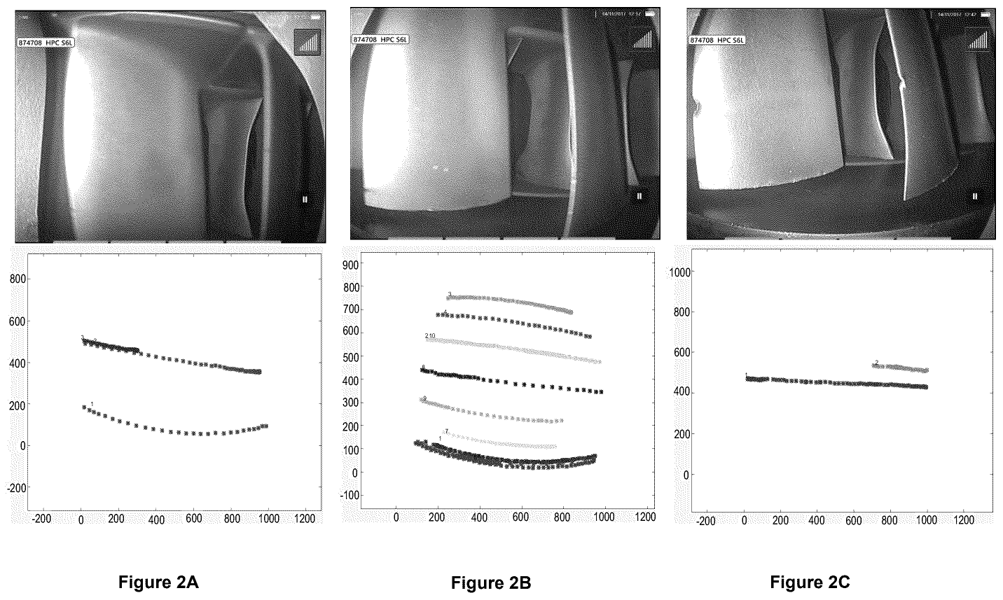

FIGS. 2A to 2C show three video frames having different camera views. FIG. 2A shows a first video frame or camera view which is directed at a top part of a rotational component. FIG. 2B shows a second video frame or camera view which is directed at a bottom part of the rotational component. FIG. 2C shows a third video frame or camera view which is also directed at a bottom part of the rotational component. FIGS. 2A to 2C also show distinct defect trajectories corresponding to the video frames or camera views, respectively. The defect trajectories may be ascertained by conventional manual methods of defect tracking and/or counting, or computer-implemented methods of defect tracking and/or counting.

In block 11 of FIG. 1, optical flow guided feature point matching is performed as follows.

In block 111, based on successive frames of the video frames, a plurality of optical flow images are ascertained for the video frames respectively. Particularly, for each pixel of each video frame, a motion vector is ascertained with respect of the particular video frame and its subsequent video frame. The successive frames include a plurality of camera views, i.e. different camera views.

Optical flow is a known technique for estimating the motion vector of each pixel on a current frame by tracking brightness patterns. It assumes spatial coherence which means that points move like their neighbors. Optical flow image may be ascertained, e.g. estimated, based on any optical flow estimation algorithm which include a differential-based, region-based, energy-based, or phase-based method. For example, optical flow image may be ascertained using FlowNet which is based on Convolutional Neural Networks (CNNs).

In block 112, based on the optical flow images, each video frame is partitioned into a plurality of regions. This partitioning may be based on similar motion which may be based on similar magnitude and angle of motion vectors of the pixels.

In block 113, based on the regions having substantially same optical flow characteristic and rotational component location, a plurality of region pairs for the successive video frames is ascertained, and feature matching for the region pairs is performed.

For example, each region pair includes a first region in a first video frame and a second region in a second video frame successive to the first video frame, wherein the first region and the second region having substantially same optical flow characteristic and rotational component location.

This region pairing is based on the assumption that pixels with the same or similar motion has similar location along the rotational component and such pixels are under a similar illumination. Under this assumption, to match the feature point from a video frame to a subsequent video frame, regions with similar location and illumination, i.e., have substantially same optical flow characteristic, are considered as pairs.

After region pairing, feature matching may be performed by applying Oriented FAST and Rotated BRIEF (ORB) matching or other features of features between the paired regions. For each region of a region pair, if there are sufficient matched feature pairs, e.g. more than a predetermined count or threshold, the region is ascertained as eligible for feature points tracking.

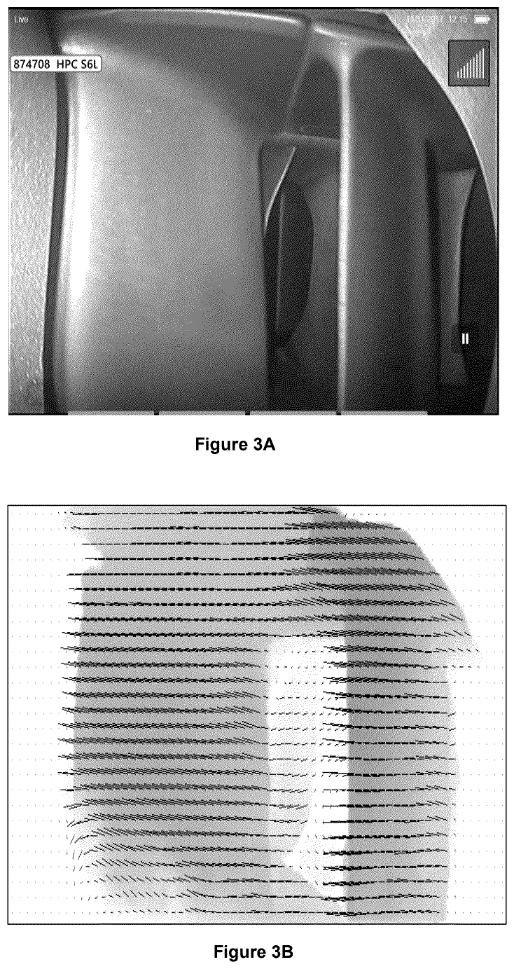

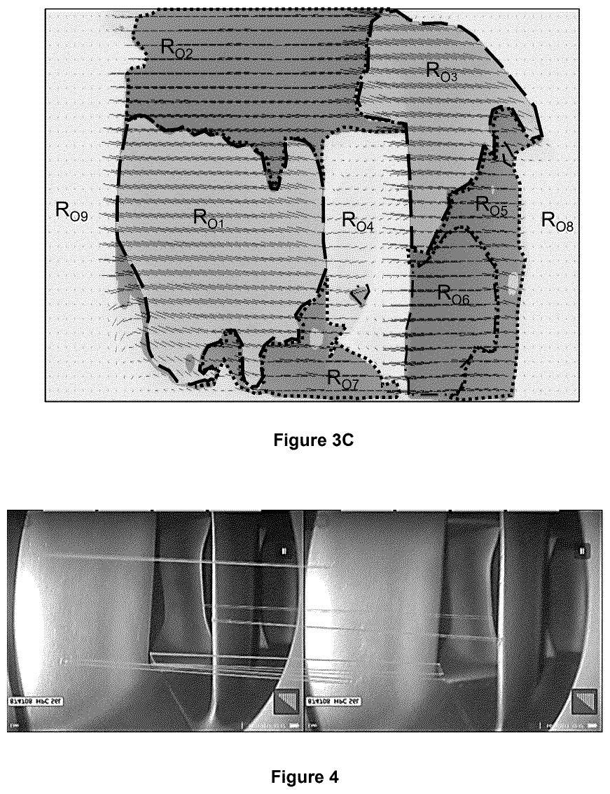

Blocks 111 to 113 may be illustrated by FIGS. 3A to 3C. FIG. 3A shows a video frame in which shows at least one rotational component. FIG. 3B shows an optical flow image of the video frame of FIG. 3A in which the optical flow image is ascertained using optical flow estimation algorithm based on an iterative residual network. In FIG. 3B, visualized small black arrows on the optical flow image indicate the motion velocity, i.e. angles and the magnitudes, of the motion vectors on specified pixels. Instead of dividing the whole optical flow image into grids, a K-Nearest Neighbour algorithm may be used for cluster grouping the motion vectors into several regions Rₒ. Among the several regions, some of them relate to static background region; some are under rather dark or bright illumination (reflection region) and some relate to rotating rotational component with normal illumination. FIG. 3C shows an optical flow image which is based on FIG. 3B and having various partitioned regions Rₒ₁, Rₒ₂, Rₒ₃, Rₒ₄ . . . , Rₒ₉. R_{O8} and R_{O9} are stationary regions where the motion vectors are hardly seen. R_{O1} is similar to R_{O3} and R_{O5} where the motions are in a right-bottom direction. R_{O2}, R_{O6} and R_{O7} moved horizontally. R_{O4} is a rotational component in the background which has a slower motion compared to the rotational components in the foreground. Then for each region Rₒᵢ, its pair region R_{di} (not shown) in the subsequent video frame is ascertained using the optical flow image of the subsequent video frame. FIG. 4 shows feature matching of region pairs performed using Oriented FAST and Rotated BRIEF (ORB) algorithm.

In block 12, a transformation matrix which characterises the camera motion between the successive frames is estimated.

In block 121, a subset of the region pairs which corresponds to a subset of the video frames having at least camera motion, i.e. having camera motion only or having combined both camera and rotational component motion, is ascertained. Particularly, optical flow images are classified to identify video frames having at least camera motion. Only these video frames, including their region pairs, would be considered for ascertaining the motion matrix.

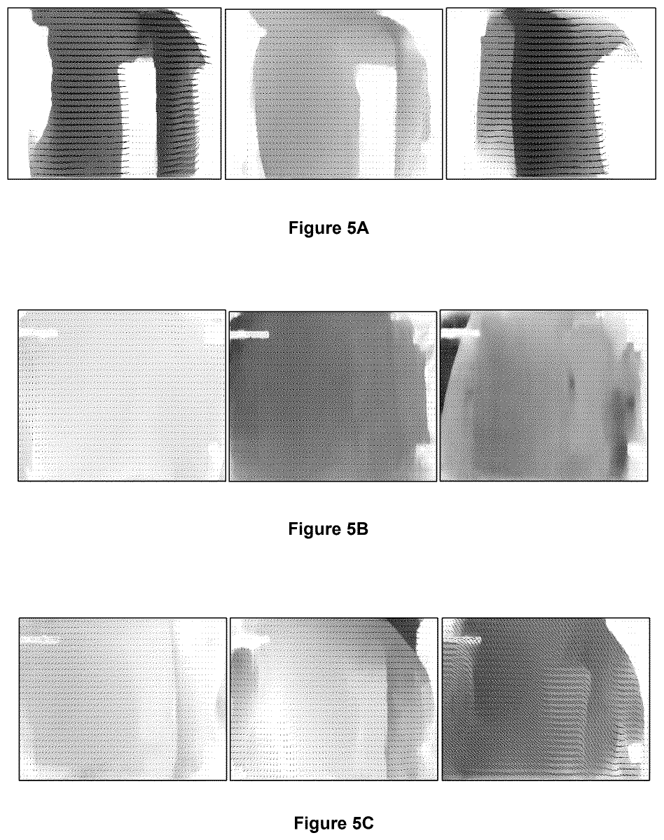

Visual odometry is the process of estimating the movement of a camera through its environment by matching point features between pairs of consecutive image frames, of which estimating camera egomotion is a classical problem. Camera egomotion may be estimated based on the optical flow images which may be classified into three categories: rotational component motion only, camera motion only and combined rotational component and camera motion. In FIG. 5A which shows three optical flow images with rotational component motion only, there are clear boundaries between rotating rotational component and stationary background. In FIG. 5B which shows three optical flow images with camera motion only, the dominant part of the whole image have a consistent motion vector. In FIG. 5C which shows three optical flow images with both rotational component and camera motion, the combined motion would produce a combination of the previous two kinds of images where the pixels on the whole frame have a motion but the boundaries between the background and the rotational components can still be detected. The classification may be performed using image classification algorithms or deep neural networks.

Once the motion type is classified, the subset of region pairs in block 121 is ascertained based on selecting video frames containing at least camera motion. If only camera motion exists, visual odometry can be solved using at least eight correspondence feature points. If both the rotational component rotation and the camera motion exist concurrently, from the optical flow images, background stationary region may be identified by clustering the motion vectors having smaller magnitude compared to the rotational component region. A threshold may be set to label the background region and the rotational component region. In order to obtain a more robust estimation, visual odometry with the identified background feature points may first be solved, subsequently outliers may be removed using Random Sample Consensus (RANSAC) algorithm for example.

Optionally, abnormal illumination, e.g. reflection region, and/or smooth region without many feature points, may be identified. Hence, the subset of region pairs in block 121 may be ascertained by excluding or filtering out region pairs having abnormal illumination and/or smooth region without many feature points.

In block 122, based on the feature matching of the subset of the region pairs, a transformation matrix for the subset of the region pairs is ascertained. Particularly, based on the subset of the region pairs, corresponding feature points between successive frames, i.e. when the camera is changing views, are ascertained based on which camera motion between the successive frames can be characterised. The transformation matrix may be ascertained using conventional techniques. For example, based on eight pairs of matched feature points on the corresponding images of two camera reference frames, an eight-point algorithm may be used to estimate the rigid camera transformation.

In block 13, trajectory mapping is performed by applying the transformation matrix to estimate trajectory mapping in successive frames. Based on the transformation matrix, a plurality of defect trajectories, e.g. ellipse-based trajectories, ascertained for each camera view or video frame is mapped onto a respective subsequent camera view or video frame.

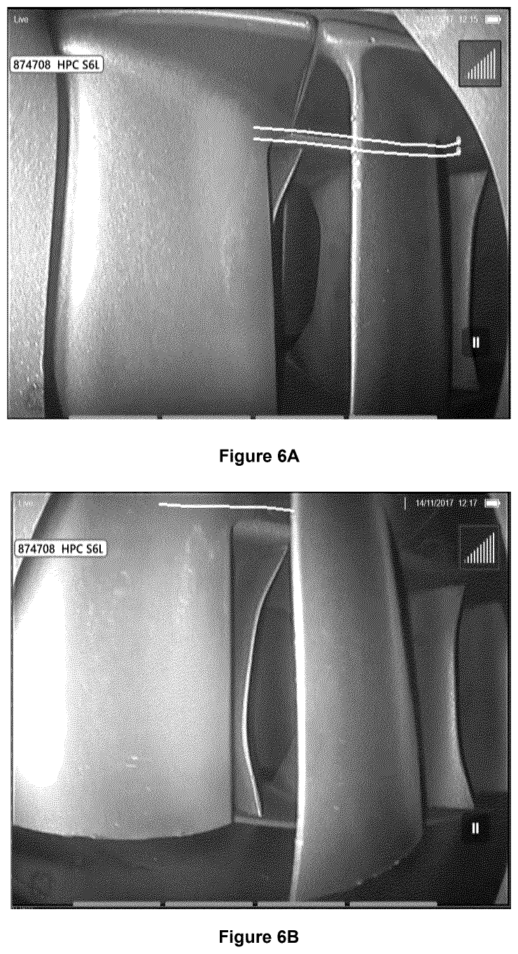

FIGS. 6A and 6B show trajectory mapping from the first camera view or video frame to the second camera view or video frame. FIG. 6A shows two defect trajectories while FIG. 6B shows one defect trajectory as the other defect trajectory is out of view.

In block 14, verification of defects is performed. This includes aggregating and matching all defects detected along the corresponding trajectories to ascertain whether they are distinct defects or same defect based on their location and/or appearance. Particularly, based on similarity of images of defects on each rotational component which correspond to a same one of the ellipse-based trajectories in each camera view or video frame and the subsequent camera view or video frame, the defects are ascertained as distinct defects or same defect. Based on the ascertained distinct defects or same defect, a count of defects may be ascertained for each camera view or video frame.

There are various methods for measuring similarity of image or patch. One is a traditional feature descriptor-based method in which different features, e.g. colour, texture, feature points, co-occurrence metric, etc., are detected from the image patches. Then, a distance measure on corresponding descriptors of the two images is applied to obtain the similarity value. Another is a perceptual method which can learn the semantic meaning of the images and mainly leverages deep neural networks. Such neural networks have been designed.

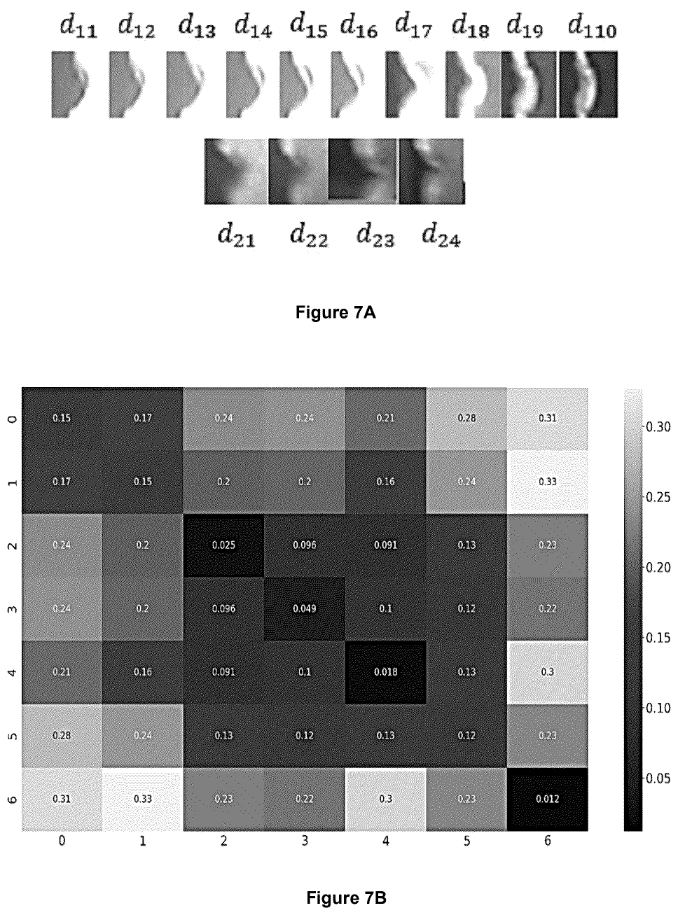

Particularly in block 14, after mapping all the defect trajectories from kₜₕ view to (k+1)ₜₕ view, the defects detected on rotational component n are compared with defect(s) on the same trajectory and the same rotational component. As the trajectories refer to whole ellipse-based trajectories of defects ascertained based on the rotational component rotation axis but not a segment of the trajectory, performance is unaffected even if the rotational component is rotating. All the snapshots of the defects in kₜₕ view and in (k+1)ₜₕ view are captured. As defects may have slightly different appearances in different illumination and view angle as illustrated in FIG. 7A, perceptual image patch similarity measures may be used to identify whether defects are potentially the same defect. Seven defects are cropped out from multiple views and their average distance is shown by the table in FIG. 7B. Lower distance values indicate higher similarity. Based on similarity of appearances of defects, e.g. table in FIG. 7B, and locations on the rotational components, the defects may be ascertained as distinct defects or same defect. For example, the defects may be ascertained as same defect if their appearances are similar and are located on the same trajectory and the same rotational component. The defects may be ascertained as distinct defects if their appearances are distinct and/or their locations are ascertained as different trajectories or rotational components.

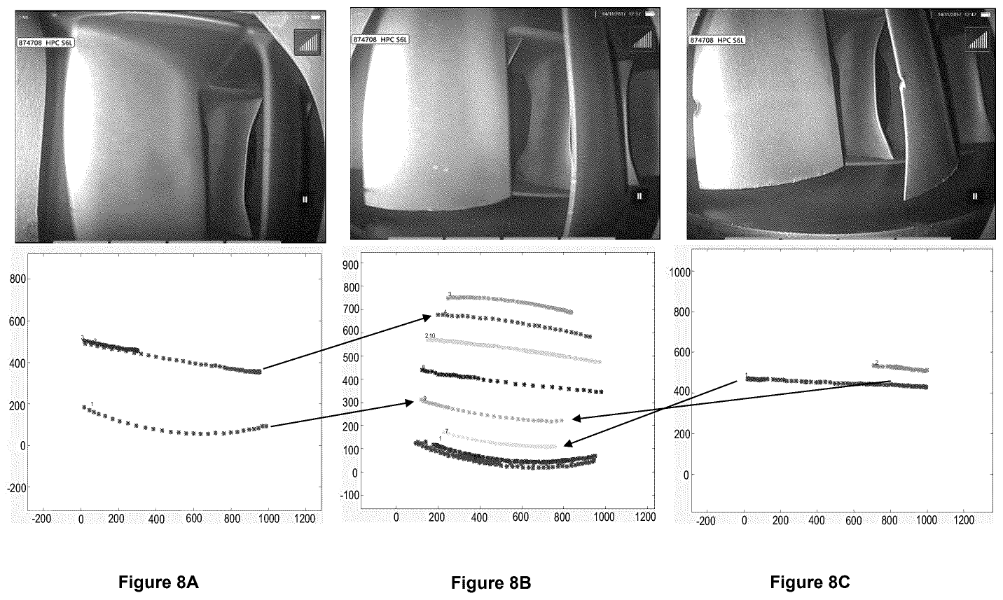

FIGS. 8A to 8C show the video sequence of FIGS. 2A to 20, their corresponding distinct trajectories of detected defects, and identification of at least some of the trajectory mappings. After trajectory mapping and merging, it is ascertained that two defects in the first view and the two defects in the third view are all detected in the second view. The correspondence to defects in the second view is indicated by the arrows in FIG. 8B. Hence, the total count of distinct defects after merging is seven as shown by the seven trajectory clusters in FIG. 8B while the total count of defects prior to merging is eleven as shown in FIGS. 8A to 8C.

According to one aspect of the disclosure, a system for inspection of rotating components may be provided. The system comprises one or more computing processor(s), memory device(s), input device(s), output device(s), communication device(s), etc. The computing processor(s) may be in cooperation or communication coupling with: memory devices(s) for storing computer-executable instructions, video data, image frames, intermediate output and/or final output; a display device for presenting any ascertained outputs to an operator, and/or a communication device for transmitting any ascertained outputs to an appropriate receiving device. Such outputs may refer to outputs in the above-described flow sequences and/or embodiments. It is to be appreciated that in the above-described methods and in the flow sequence of FIG. 1, the various steps may be performed or implemented by the computing processor(s).

According to one aspect of the disclosure, a non-transitory computer-readable medium having computer-readable code executable by at least one computing processor is provided to perform the methods/steps as described in the foregoing.

Embodiments of the disclosure provide at least the following advantages:
Information of defects captured from multiple camera views can be ascertained based on optical flow and feature aggregation.
By using optical flow, camera motion may be distinguished from rotational component motion.
By partitioning optical flow images, feature matching would be confined to a local region of the moving rotational component region. This would reduce matching area as compared to whole frame matching. This would also increase the reliability and accuracy of feature matching as compared to whole frame matching. For example, grid-based method for whole frame matching may result in a significant number of matches but may lack accuracy due to non-distinctive blade regions of rotational components.

Other embodiments will be apparent to those skilled in the art from consideration of the specification and practice of the disclosure. Furthermore, certain terminology has been used for the purposes of descriptive clarity, and not to limit the disclosed embodiments. The embodiments and features described above should be considered exemplary.

1. A method for inspection of rotational components, the method comprising:
based on successive frames of a plurality of video frames of the rotational components in motion, each video frame having a plurality of pixels, ascertaining a plurality of optical flow images for the video frames respectively by ascertaining a plurality of motion vectors of the pixels, wherein the successive video frames include a plurality of camera views;
based on the optical flow images, partitioning each video frame into a plurality of regions;
based on regions having substantially same optical flow characteristic and rotational component location, ascertaining a plurality of region pairs for the successive video frames and performing feature matching for the region pairs;
ascertaining a subset of the region pairs which correspond to a subset of the video frames having at least camera motion;
based on the feature matching of the subset of the region pairs, ascertaining a transformation matrix for the subset of the region pairs; and
based on the transformation matrix, performing mapping of a plurality of defect trajectories of each camera view to a subsequent camera view, wherein the camera views include the subsequent camera view.

2. The method of claim 1, further comprising:
based on similarity of images of defects on each rotational component which correspond to a same one of the defect trajectories in each camera view and the subsequent camera view, ascertaining the defects as distinct defects or same defect.

3. The method of claim 2, further comprising:
for each rotational component, based on the ascertained distinct defects or same defect, ascertaining a count of distinct defects thereon.

4. The method of claim 1, wherein the defect trajectories include ellipse-based trajectories.

5. The method of claim 1, wherein ascertaining the subset of the region pairs which correspond to the subset of the video frames having the at least camera motion includes:
excluding some of the region pairs which include abnormal illumination and/or smooth region.

6. The method of claim 1, wherein ascertaining the subset of the region pairs which correspond to the subset of the video frames having the at least camera motion includes:
classifying the optical flow images and thereby ascertaining some of the optical flow images having the at least camera motion.

7. A system for inspection of rotational components, the system comprising:
a memory device storing a plurality of video frames; and
a computing processor communicably coupled to the memory device and configured to:
based on successive frames of a plurality of video frames of the rotational components in motion, each video frame having a plurality of pixels, ascertain a plurality of optical flow images for the video frames respectively by ascertaining a plurality of motion vectors of the pixels, wherein the successive video frames include a plurality of camera views;
based on the optical flow images, partition each video frame into a plurality of regions;
based on regions having substantially same optical flow characteristic and rotational component location, ascertain a plurality of region pairs for the successive video frames and perform feature matching for the region pairs;
ascertain subset of the region pairs which correspond to a subset of the video frames having at least camera motion;
based on the feature matching of the subset of the region pairs, ascertain a transformation matrix for the subset of the region pairs;
based on the transformation matrix, perform mapping of a plurality of ellipse-based trajectories of each camera view to a subsequent camera view, wherein the camera views include the subsequent camera views.

8. The system of claim 7, wherein the computing processor is further configured to:
based on similarity of images of defects on each rotational component which correspond to a same one of the ellipse-based trajectories in each camera view and the subsequent camera view, ascertain the defects as distinct defects or same defect.

9. The system of claim 8, wherein the computing processor is further configured to:
for each rotational component, based on the ascertained distinct defects or same defect, ascertain a count of distinct defects thereon.

10. The system of claim 7, wherein the defect trajectories include ellipse-based trajectories.

11. The system of claim 7, wherein the computing processor is configured to ascertain the subset of the region pairs which correspond to the subset of the video frames having the at least camera motion by being further configured to:
exclude some of the region pairs which include abnormal illumination and/or smooth region.

12. The system of claim 7, wherein the computing processor is configured to ascertain the subset of the region pairs which correspond to the subset of the video frames having the at least camera motion by being further configured to:
classify the optical flow images and thereby ascertaining some of the optical flow images having the at least camera motion.

13. A non-transitory computer-readable medium having computer-readable code executable by at least one computing processor to perform the method according to claim 1.
